(19) United States
(12) Patent Application Publication
(10) Pub. No.: US 2002/0077807 A1
(43) Pub. Date: Jun. 20, 2002

(54) Pseudo language test system and method

(75) Inventors: Gregory Peter Davis, Raleigh, NC (US); David Bruce Kumhyr, Austin, TX (US); Douglas Brian Mueller, Holy Springs, NC (US); Jinfang Chen, Austin, TX (US)

Correspondence Address: Intellectual Property Law Dept., IBM Corporation, 11400 Burnet Road, Zip 4054, Austin, TX, 78758, US

(73) Assignee: International Business Machines Corporation

(21) Appl. No.: 09/737,456

(22) Filed: Dec. 14, 2000

(51) Int. Cl. G06F 17/20; G10L 15/00

(52) U.S. Cl. 704/8; 704/231

(57) ABSTRACT

A pseudo language system and method are disclosed that permit an operator to meaningfully test multibyte character data in an application such as a software application. The operator can enter single byte characters through an input device. The pseudo language keyboard utility then transcribes the single byte characters into multibyte characters of a pseudo language. The pseudo language characters are entered into the application under test and may be displayed and/or printed. The multibyte pseudo language characters are preferably constructed to appear visually recognizable to the native language of the operator. In this manner, the operator can determine whether the testing has been successful or not as is especially desirable for initial application testing.

### BACKGROUND OF THE INVENTION

1. Field of the Invention

The present invention relates generally to software application verification testing and, more particularly, to apparatus and methods for entering multibyte test data for globalization testing.

2. Description of the Background

In order for an application program to practically useful it must be capable of presenting information which reflects the users' cultural preferences (language and conventions) and allow users to interact with the application according to their cultural preference. Typically, the cultural preference of an application program is customized for a specific market (geographical region or country). However, application programs are relatively inflexible in allowing users to alter the application's cultural preference to their particular needs.

Therefore, operating systems have been developed which contain cultural information that is sometimes referred to as a “locale.” For example, the local model may define six categories of cultural variables, which are collectively referred to as locale categories: character collation, character attributes and mappings, monetary formatting, numeric data formatting, data and time formatting and messages. Chinese or Japanese alphabets may include tens of thousands of characters, e.g., 14,000 characters. Therefore, the Chinese and Japanese characters require a multibyte representation thereof such as double byte representations rather than single byte representations which may be used to represent the much smaller character set of English.

A problem arises in testing applications especially for oriental languages. In international testing the use of mock language translation of the application resources has become a standard method of worldwide verification testing. However, the US English-speaking testers are still handicapped in using Oriental operating systems to attempt to enter multibyte user data as required for Chinese and Japanese characters. So entered data may not be tested completely or accurately due to language understanding difficulties. Especially at early stages of application development, there may be difficulty with finding sufficient testers that are proficient in the various languages that may be used in the application. Therefore, it would be desirable to provide some means that would allow, for instance, English speakers to generate meaningful mulbibyte data, such as Chinese or Japanese characters, into an application under test and verify the output/throughput without the need to have the ability to read, for instance, Chinese language characters.

Various patents relate to locales including the following:

U.S. Pat. No. 5,835,768, issued Nov. 10, 1998, to Miller et al., discloses a system for presenting information which reflects the user's cultural preference, including language and other conventions, that can manage local categories without requiring application programs to manage all the overhead of repetitive changes to locale category values. Users merely specify their cultural preferences through the application programs and the operating system assigns a stack from the working memory fore each specified category of cultural preference, and pushes onto the stack the location in the in the working memory of a file for the category of cultural preference specified, the file having been transferred from a locale database of files that contain code for formatting according to the cultural preferences In a second aspect of the operating system, multiple concurrent sets of cultural preferences are handled by determining whether a location in the working memory corresponding to the preference specified is currently in the queue, and if not, by placing a new value in the queue for each memory location corresponding to an additional set of locale category values.

U.S. Pat. No. 5,513,342, issued Apr. 30, 1996, to Leong et al., discloses a graphical user interface display window configuration containing user-readable data and is implemented by a software presentation system. The software presentation system automatically adjusts window size and positioning in accordance with window environment changes (e.g., change in user readable data and/or window resolution). The method includes steps of establishing through operation of the presentation system, a display including windows with user-readable data, detecting a change in window environment, responding automatically to the changes in window environment to determine windows in the display that require a size adjustment, recalculating the size of each window that requires adjustment, and operating a layout routine to reposition windows in the display in accordance with predetermined spacing and positioning parameters.

U.S. Pat. No. 4,595,980, issued Jun. 17, 1986, to J. G. Innes, discloses a distributed, interactive data processing system provided with the ability to allow concurrent multilingual use by a plurality of users having different national language preferences and is further provided with the ability to be independent of the national language in which an input to the data processing system is received. A message model data collection is established by storing message models via a message identifier primary key and a secondary key that is the national language index. A central message service is used to compose messages from the message models retrieved from the message model data collection using the primary and secondary keys in response to a call from an application, application control, or supervisor program. The calling program stores a message identifier primary key as the value of a variable and causes an event to be stacked for an event handler. The event handler uses the message identifier to request composition of that message from central message service. Central message service determines the user's national language index which together with the message identifier allow the message model to be retrieved from the message model data collection, and the menage to be composed and stored in a variable accessible to the event handler. The event handler uses that information to store values in variable accessible to the calling program. The calling program can then use the contents of those variables to determine whether the user's input has meaning recognized by the program.

While the above listed patents relate to locales, such as used in operating systems, they do not provide means for testers who do not speak or recognize certain language or characters to adequately test those aspects of the program. Consequently, it would be desirable to have a means that would permit testers to thoroughly test an application and verify output/throughput without the need to recognize foreign languages. Those skilled in the art have long sought and will appreciate the present invention which provides solutions to these and other problems.

### SUMMARY OF THE INVENTION

The present invention was designed to provide an improved method for testing an application with multibyte character sets.

Another object of the present invention is to provide an improved utility for testing applications.

An advantage of the present invention is that English speaking persons can test applications used with foreign language character sets wherein each character is represented by plurality of bytes.

Therefore, the present invention may provide for a method for functional testing of an application that uses locale data format comprising steps such as inputting a message in a first language using an input device where the first language has first language characters such that each character is represented with a single byte. Other steps may include translating the message into a pseudo language where the pseudo language comprises pseudo language characters wherein each character is represented by a plurality of bytes Additional steps may include inputting the pseudo language character images into the application and/or displaying and/or printing the pseudo graphical character images using the application.

Preferably, the pseudo language character images are graphically similar to the first language characters so as to be recognizable in the step of displaying and/or printing. The step of translating may further comprise translating each of the first language characters into a corresponding of the pseudo language characters

In one embodiment, the method may further comprise providing a lookup table such that the first language characters can be used to reference the pseudo language characters. In a preferred embodiment, the first language comprises U.S. English characters and/or the step of inputting further comprises utilizing a keyboard.

However, the invention may be implemented in different ways. For example only, a keyboard driver may be used, an application may be written that remaps the keystrokes, or yet other means may be used such as a Java application.

The present invention may comprise a test system for an application that may have elements such as an input device capable of generating first language characters wherein each language character is represented by a single byte, a utility for generating pseudo language characters wherein each pseudo language character is represented by a plurality of bytes in response to receiving the first language characters from the input device, and/or a display such as a printer or monitor for displaying the pseudo language characters from the application.

In other words, the present invention may comprise a method for testing multibyte character data in an application and may include steps such as inputting a first language character represented by a single byte, translating the character into a pseudo language character represented by a plurality of bytes, and utilizing the pseudo language character in the application.

The foregoing and other objects, features, advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematical representation which discloses an embodiment for a method of testing an application with multibyte characters in accord with the present invention; and

FIG. 2 is a schematical block diagram of a system in accord with the present invention.

While the present invention will be described in connection with presently preferred embodiments, it will be understood that it is not intended to limit the invention to those embodiments On the contrary, it is intended to cover all alternatives, modifications, and equivalents included within the spirit of the invention.

### DETAILED DESCRIPTION

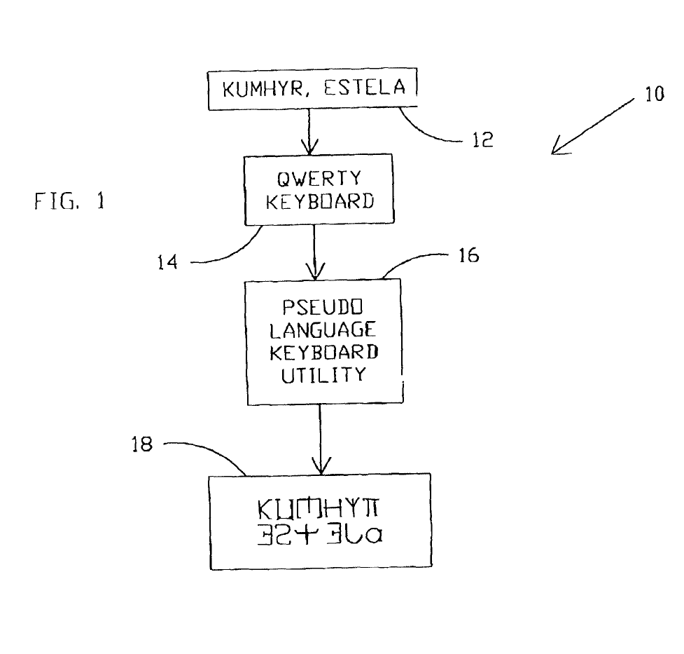

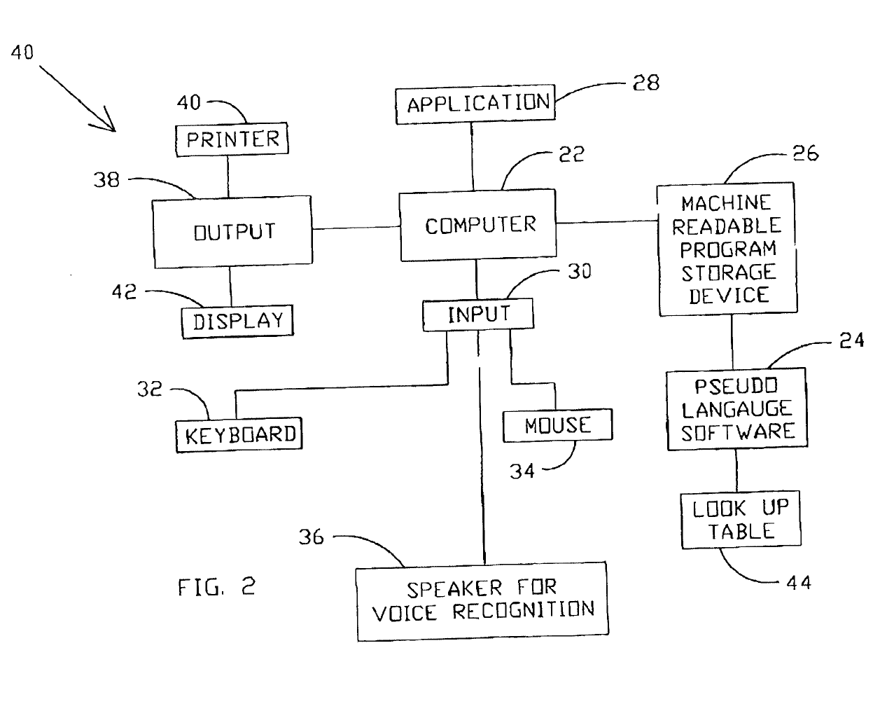

Referring now to FIG. 1, there is shown a diagram that discloses an embodiment of a pseudo language method 10 in accord with the present invention. The present invention allows an operator testing an application to input English or other characters represented by single byte as indicated at 12. The single byte input data is entered via an input device such as QWERTY keyboard 14. Other input devices could also be used such as different types of keyboards or completely different input devices such as word recognition systems, selection from a menu with a mouse, or other means (See FIG. 2).

When single byte data is received by pseudo language keyboard utility 16, multibyte data is generated in the form of pseudo language characters. For instance, U.S. English characters may be entered into pseudo language utility 16 and then automatically transcribed into multibyte characters. In one embodiment, a look up table may be provided such that for each single byte input character, a multibyte output pseudo language character is produced based on the table which includes an output for each input. Alternatively, a plurality of input characters may be used to produce one output pseudo language character. As another alternative, a single input character or other input may be used to produce a plurality of multibyte output pseudo language characters such as a phrase, paragraph, page, or pages for testing. However, the invention may be implemented in different ways. For example only, a keyboard driver may be used, an application may be written that remaps the keystrokes, or yet other means may be used such as a Java application.

The output pseudo language characters are entered into the application under test and displayed as indicated at 18. In a presently preferred embodiment, the pseudo language characters are shaped to conform similarly to the language used by the operator, such as English Thus, the output shown at 18 is recognizable by the tester. The tester can thereby insert a plurality of pseudo language multibyte characters for testing, especially initial testing, and be able to confidently view the results knowing whether the characters are correctly produced or not. In this manner, multibyte character set data can be thoroughly tested in the application.

FIG. 2 discloses system 20 in accord with the present invention. System 20 enables computer or processor 22 to utilize pseudo language software 24 according to a preferred embodiment of the present invention. Pseudo language software 24 may be provided on machine readable storage device 26 which may include any type of memory such as CD ROM, floppy disks, hard disk, semiconductor, or any other type of memory and may also include multiple memory devices such as, for example only, removable disks, non-removable disks, and semiconductors wherein data may be transferred therebetween as desired. Application 28 under test, as discussed hereinbefore, may include the various types of software that preferably use locale information as supplied by an operating system that may also be contained in the same or other memory as the memory of machine readable storage device 26. Input 30 may include numerous types of input devices some of which are shown herein and may include keyboard 32, mouse 34, and speaker 36 for voice recognition. Any of these input devices, or others, can be used to select and/or generate multibyte data in accord with the present invention such as for testing multibyte characters that may be used in characters for languages such as Chinese and Japanese, for example only. Output 38 may be of various types as needed for thorough testing of application 28. For example, for visual output testing, as may be desired, display 42 and/or printer 40 may be used. Other types of output 38 may be used in accord with the requirements of application 28 that is being tested and may include machine readable output for automatic testing wherein a machine may also be used to input data thereby automating the process, where desired such as for initial testing.

Pseudo language software may provide for lookup table 44 wherein single byte data is correlated with multibyte data, as discussed hereinbefore. Thus, multibyte characters can be generated using single byte input information and an operator can display the multibyte data that is formatted to permit determination of whether the test was successful or not.

Thus, in operation, an operator may enter single byte data to computer 22 for testing with application 28 wherein multibyte data is an input to application 28 such as might be used with languages such as Chinese or Japanese or any other language or input best represented multibyte data. Input devices such as keyboard 32 or other means may be used for inputting the single byte data. Pseudo language software 26 such as, for instance, pseudo language keyboard utility 16, may be used to produce multibyte data for input to application 28 in response to the single byte data that has been entered. The operator can then verify the output of application 28 by viewing display 42 or other suitable output means. The output is preferably of a form that is readable by an operator in the operator's language and may include something like that as indicated at 18 or any other output that may be recognizable by the operator for testing purposes.

Therefore, the foregoing disclosure and description of the invention is illustrative and explanatory thereof, and it will be appreciated by those skilled in the art, that various changes in the size, shape and materials, the use of mechanical equivalents, as well as in the details of the illustrated construction or combinations of features of the various elements may be made without departing from the spirit of the invention.

What is claimed is:

1. A method for functionally testing an application that uses locale data format, comprising:
inputting a message in a first language using an input device, said first language having first language characters wherein each character is represented with a single byte;
translating said message into a pseudo language, said pseudo language being comprised of pseudo language characters wherein each character is represented with a plurality of bytes;
inputting said pseudo language character images into said application, and
displaying said pseudo language character images using said application.

2. The method of claim 1, wherein:
said pseudo language character images are graphically similar to said first language characters so as to be recognizable in said step of displaying.

3. The method of claim 1, wherein said step of translating further comprises:
translating each of said first language characters into a corresponding of said pseudo language characters.

4. The method of claim 1, further comprising:
providing a lookup table such that said first language characters can be used to reference said pseudo language characters.

5. The method of claim 1, further comprising:
wherein said first language is comprised of U.S. English characters.

6. The method of claim 1, wherein said inputting further comprises utilizing a keyboard.

7. A test system for an application, comprising:
an input device for generating first language character data wherein each language character is represented by a single byte;
software for generating pseudo language character data wherein each pseudo language character is represented by a plurality of bytes in response to receiving said first language character data from said input device; and
a display for displaying said pseudo language characters with said application.

8. The test system of claim 7, wherein:
said pseudo language characters correspond to said first language characters so as to be graphically similar to said first language characters.

9. The test system of claim 7, wherein said first language characters are U.S. English characters

10. The test system of claim 7, wherein said utility further comprises:
a table comprised of a plurality of pseudo language character data wherein each pseudo language character is represented by a plurality of bytes.

11. The test system of claim 7, wherein said input device further comprises:
a keyboard.

12. A method for testing multibyte character data in an application, said method comprising:
inputting single byte data;
translating said single byte data into a pseudo character represented by a plurality of bytes; and
utilizing said pseudo character in said application.

13. The method of claim 12, further comprising:
displaying said pseudo character using said application

14. The method of claim 12, further comprising:
providing that said pseudo character is recognizable as compared to a first language character.

15. The method of claim 14, wherein:
said first language comprises U.S. English.

16. The method of claim 14, further comprising:
inputting a string of first language characters wherein each of said first language characters are representable with a single byte.

17. The method of claim 12, further comprising:
utilizing a keyboard for said step of inputting.

18. The method of claim 12, further comprising:
providing a lookup table comprising a plurality of said pseudo language character data.

19. A program storage device readable by a machine, said program storage device embodying a program of instructions executable by the machine to perform a method for testing multibyte character data in an application, said method comprising:
inputting single byte data;
translating said single byte data into a pseudo character represented by a plurality of bytes; and
utilizing said pseudo character in said application.

20. The program storage device of claim 19, said method further comprising:
displaying said pseudo character using said application.

21. The program storage device of claim 19, said method further comprising:
providing that said pseudo character is recognizable as compared to a first language character.

22. The program storage device of claim 21, said method further comprising:
said first language comprises U.S. English.

23. The program storage device of claim 21, said method further comprising:
inputting a string of first language characters wherein each of said first language characters are representable with a single byte

24. The program storage device of claim 19, said method further comprising:
utilizing a keyboard for said step of inputting.

25. The program storage device of claim 19, said method further comprising:
providing a lookup table comprising a plurality of said pseudo language character data.
